(19) United States
(12) Patent Application Publication
(10) Pub. No.: US 2024/0242710 A1
(43) Pub. Date: Jul. 18, 2024

(54) SYSTEM AND METHOD FOR UPDATING LANGUAGE MODELS

(71) Applicant: VIA TECHNOLOGIES, INC., New Taipei City (TW)

(72) Inventors: Jiah-Hui LUO, Shanghai (CN); Jing-Jing GUO, Shanghai (CN)

(21) Appl. No.: 18/302,180

(22) Filed: Apr. 18, 2023

(30) Foreign Application Priority Data
Jan. 17, 2023 (CN) 202310070814.1

(51) Int. Cl. G10L 15/065; G10L 15/16; G10L 15/18

(52) U.S. Cl. CPC G10L 15/065; G10L 15/16; G10L 15/18

(57) ABSTRACT

A system for updating language models is provided. The system includes a data-storage module, a data-update module, and a model-building module. The data-storage module is used for storing multiple pieces of corpus data that corresponds to multiple categories. The data-update module is used for storing a piece of new corpus data into the data-storage module. The piece of new corpus data corresponds to one of the categories. The model-building module is used for building a plurality of classified language models, and for updating one of the classified language models based on the piece of new corpus data stored in the data-storage module. The classified language model updated corresponds to the category that corresponds to the piece of new corpus data.

### CROSS REFERENCE TO RELATED APPLICATIONS

This application claims priority of China Patent Application No. 202310070814.1, filed on Jan. 17, 2023, the entirety of which is incorporated by reference herein.

### BACKGROUND OF THE INVENTION

### Field of the Invention

The present invention relates to natural language processing technologies, and, in particular, to a system and a method for updating language models.

### Description of the Related Art

Language models refer to the probability distribution between sentences or words. They are often used in various natural language processing applications, such as speech recognition, machine translation, part-of-speech tagging, syntactic analysis, handwriting recognition, and information retrieval. For example, in speech recognition applications, the pronunciation of the word “bond” is very similar to “band”, so the acoustic model alone is not enough to accurately determine which word the speaker is referring to. The acoustic model must work with the language model to infer from the context whether the speaker actually meant “bond” or “band”. Specifically, if the speaker utters a word that sounds similar to “investment” before the word, the word is more likely to be “bond”. If the speaker utters a word that sounds similar to “rock” before the word, the word is more likely to be “band”.

Language models are usually trained using a generic corpus. Such generic language models lack pertinence in application fields, leading to unsatisfactory results in practical applications. Especially when speech recognition is applied, speech with similar pronunciation is often misjudged. For example, when a generic language model is used in the field of financial management applications, the speaker's “recommend a bond” may be misinterpreted as “recommend a band” due to the lack of corpus related to the word “bond”. In another example, when a generic language model is used in the field of science or geography, the speaker's “the altitude at which you are exercising affects your level of fatigue” may be misinterpreted as “the aptitude of you when you are exercising affects your level of fatigue” due to the lack of vocabulary related to numbers and four arithmetic operations in the corpus. In addition, when the user needs to update the language model, due to the large amount of corpus required by the generic language model, and due to the conventional practice requiring the merging of the old corpus with the new corpus to rebuild the entire language model, associated time consumption and computing resources are very considerable issues.

Therefore, it is desirable to have a system and method for updating language models to solve the problems described above.

### BRIEF SUMMARY OF THE INVENTION

An embodiment of the present disclosure provides a system for updating language models. The system includes a data-storage module, a data-update module, and a model-building module. The data-storage module is used for storing multiple pieces of corpus data that corresponds to multiple categories. The data-update module is used for storing a piece of new corpus data into the data-storage module. The piece of new corpus data corresponds to one of the categories. The model-building module is used for building a plurality of classified language models, and for updating one of the classified language models based on the piece of new corpus data stored in the data-storage module. The classified language model updated corresponds to the category that corresponds to the piece of new corpus data.

An embodiment of the present disclosure provides a method for updating language models, for use in a computer system. The method includes storing a piece of new corpus data into a data-storage module of the computer system, and updating one of a plurality of classified language models based on the piece of new corpus data stored in the data-storage module. The data-storage module is used for storing multiple pieces of corpus data corresponding to multiple categories. The piece of new corpus data corresponds to one of the categories. The classified language model updated corresponds to the category that corresponds to the piece of new corpus data.

### BRIEF DESCRIPTION OF THE DRAWINGS

The present invention can be more fully understood by reading the subsequent detailed description and examples with references made to the accompanying drawings. Additionally, it should be appreciated that in the flow diagram of the present disclosure, the order of execution for each blocks can be changed, and/or some of the blocks can be changed, eliminated, or combined.

FIG. 1 is a system block diagram illustrating a system for updating language models, according to an embodiment of the present disclosure;

FIG. 2 is a flow diagram illustrating a method for updating language models, according to an embodiment of the present disclosure;

FIG. 3 is a flow diagram illustrating a method for updating language models, according to an embodiment of the present disclosure;

FIG. 4 is a system block diagram illustrating a system for updating language models, according to an embodiment of the present disclosure;

FIG. 5 is a flow diagram illustrating a method for updating language models, according to an embodiment of the present disclosure;

FIG. 6 is a flow diagram illustrating more detailed steps of determining the corresponding category of the new corpus data, according to an embodiment of the present disclosure; and

FIG. 7 is a system block diagram illustrating a system for updating language models, according to another embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The article “one” used in this specification and the claims is not intended to limit the present disclosure to “only one”. For example, “a piece of new corpus data” can include the aspect of “one or more pieces of new corpus data”, “one of the categories” can include the aspect of “one or more of the categories”, and “one of the classified language models” can include the aspect of “one or more of the classified language models”.

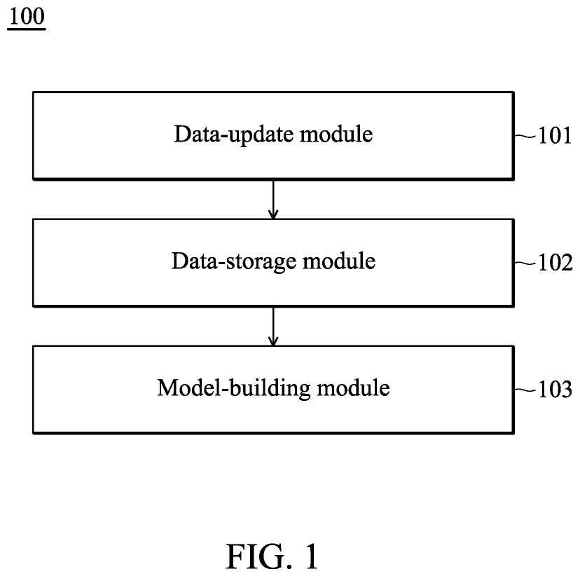

FIG. 1 is a system block diagram illustrating a system 100 for updating language models, according to an embodiment of the present disclosure. As shown in FIG. 1, the system 100 may include a data-update module 101, a data-storage module 102, and a model-building module 103.

The system 100 may be a computer system, such as a personal computer (e.g., a desktop computer or a notebook computer) or a server computer running an operating system (e.g., Windows, Mac OS, Linux, UNIX, etc.).

The data-update module 101 and the model-building module 103 may be implemented by loading a program containing a plurality of instructions into the processing device of the system 100. A processing device may be any device for executing instructions, such as a central processing unit (CPU), a graphics processing unit (GPU), a microprocessor, a controller, a microcontroller, or a state machine.

The data-storage module 102 may be implemented by a storage device of the system 100. The storage device may be any device containing non-volatile memory (e.g., read-only memory, electronically-erasable programmable read-only memory (EEPROM), flash memory, non-volatile random access memory (NVRAM)), such as a hard disk (HDD), a solid state disk (SSD), or an optical disk.

The data-storage module 102 is used for storing multiple pieces of corpus data corresponding to multiple categories. The corpus data are for use in building the language model. Each piece of corpus data may be a complete sentence (e.g., “what is the weather tomorrow”), or a paragraph composed of multiple short sentences (e.g., “the weather will be good tomorrow, suitable for outgoing”). The length of each piece of corpus data is not limited by the present disclosure. The category may refer to various languages, such as Simplified Chinese, Traditional Chinese, English, Spanish . . . etc. The category may also refer to various application scenarios, such as interactive teaching, daily life information query, navigation, smart home appliance control, calculator, etc. The category may also refer to the subdivision of the above example application scenarios. For example, the application scenarios of interactive teaching may be subdivided into categories such as Chinese literature, mathematics, history, etc., and the application scenarios of daily life information query may be subdivided into categories such as weather, air quality, traffic conditions, etc. The type and quantity of categories are not limited by the present disclosure. Categories may be labeled manually, or be automatically identified by the system. Various implementations of automatically identifying the category (or categories) corresponding to the corpus data will be described later.

It should be noted that the present disclosure does not limit each piece of corpus data to only correspond to one category. Conversely, each piece of corpus data may correspond to multiple categories. For example, the corpus data “what is the weather tomorrow” may correspond to the categories of “English” and “daily life information query”. In the context of interactive teaching, the corpus data “who are the Eight Great Prose Masters of the Tang and Song Dynasties” may correspond to the categories of “Chinese literature” and “history”.

The data-update module 101 is used for storing new corpus data into the data-storage module 102. The new corpus data may be downloaded from publicly available online corpora, such as Corpus of Contemporary American English (https://www.english-corpora.org), University of Pennsylvania Corpora (https://www.ldc.upenn.edu/new-corpora), Corpus of Contemporary Taiwanese Mandarin (https://coct.naer.edu.tw/), Chinese National Corpus (http://cascorpus.com/link-detail/542132), etc. but the present disclosure is not limited thereto. The new corpus data may also be input by the user through the input device of the system 100, such as keyboard, mouse, scanner, touch panel, microphone, etc. or any combination thereof, but the present disclosure is not limited thereto.

The model-building module 103 is used for building classified language models. Unlike the generic language model, which is trained using a huge and complex corpus, the classified language model is trained by the model-building module 103 using the corpus data corresponding to a specific category in the data-storage module 102 only. For example, the model-building module 103 only uses the corpus data corresponding to the category of “Chinese literature” to train the first classified language model, merely uses the corpus data corresponding to the category of “mathematics” to train the second classified language model, and uses the corpus data corresponding to the category of “History” to train the third classified language model only, and so on. As such, the first classified language model, the second classified language model, and the third classified language model may significantly improve their performance in the context of interactive teaching of Chinese literature, mathematics, and history respectively, due to the increase in the relative proportion of corpus data related to Tang poetry and Song Ci, four arithmetic operations, and ancient deeds.

In an embodiment of the present disclosure, the model-building module 103 is further used for updating the classified language model based on the new corpus data stored in the data-storage module 102, and the classified language model updated corresponds to the category that corresponds to the new corpus data. For example, the new corpus data “Who are the Eight Great Prose Masters of the Tang and Song Dynasties” corresponds to the categories of “Chinese literature” and “history”. Based on the new corpus data, the model-building module 103 updates the first classified language model that corresponds to the “Chinese literature” category, and updates the third classified language model that corresponds to the “history” category, but does not update the second classified language model that corresponds to the “mathematics” category or other classified language models.

In an embodiment, in addition to updating the classified language model based on the new corpus data, the model-building module 103 may also update the generic language model based on the new corpus data. For example, based on the new corpus data “Who are the Eight Great Prose Masters of the Tang and Song Dynasties”, the model-building module 103 may not update the first classified language model that corresponds to the category of “Chinese literature” and the third classified language model that corresponds to the category of “history” only, but also update the generic language model.

In an embodiment, the classified language model uses n-grams to calculate the probability scores between words in the corpus data corresponding to the category that corresponds to the classified language model. N-gram is a probabilistic language model based on (n−1) order Markov chain, which infers the structure of sentences through the probability of appearance of n words.

The following <Table 1> shows an example of the probability scores between words obtained after the fourth classified language model corresponding to the “daily life information query” category is trained using 2-gram.

TABLE 1

| | | | | | San | | |
|---|---|---|---|---|---|---|---|
| | I | you | he | tomorrow | Francisco | Chicago | . . . |
| I | 0 | 0.0033 | 0.0031 | 0.33 | 0.00254 | 0.0062 | |
| you | 0.065 | 0 | 0.0088 | 0.54 | 0.000021 | 0.00234 | |
| he | 0 | 0 | 0 | 0.24 | 0.00234 | 0.000011 | |
| tomorrow | 0.071 | 0.093 | 0.056 | 0 | 0.055 | 0.0354 | |
| San | 0.000016 | 0.000123 | 0.00634 | 0.65 | 0 | 0.005452 | |
| Francisco | | | | | | | |
| Chicago | 0.000123 | 0.00634 | 0.000016 | 0.72 | 0.0086 | 0 | |
| . . . | | | | | | | |

In the example shown in <Table 1>, the value in the second row of the fifth column is 0.33, indicating that among the corpus data corresponding to the “daily life information query” category, the probability of the word “I” being followed by the word “tomorrow” is 0.33, and the mathematical expression is P(tomorrow|I)=0.33. The value in the fifth row of the fourth column is 0.056, indicating that among the corpus data corresponding to the “daily life information query” category, the probability of the word “tomorrow” being followed by the word “he” is 0.056, and the mathematical expression is P(he|tomorrow)=0.056. The value in the fourth row of the third column is 0, indicating that among the corpus data corresponding to the “daily life information query” category, the probability of the word “he” being followed by the word “you” is 0, and the mathematical expression is P(you|he)=0. In other words, there is no word “he” being followed by the word “you” in any piece of corpus data corresponding to the “daily life information query” category.

In an embodiment, the model-building module 103 updates the language model in an incremental manner. Specifically, the model-building module 103 updates the classified language model by only updating the probability scores between words in the new corpus data, and not updating the probability scores of words that are not in the new corpus data.

For example, assuming that before the fourth classified language model is updated, among the corpus data corresponding to the “daily life information query” category, the words “I”, “want”, “tomorrow”, and “weather” appear 200, 150, 50, and 30 times, respectively, and the phrases “I want” and “weather tomorrow” appear 45 times and 32 times, respectively (the number of appearance of other words are not provided in this example). Based on the above information, it may be calculated that the probability of the word “I” being followed by the word “want” is 45/200=0.225, and the probability of the word “weather” being followed by the word “tomorrow” is 32/50=0.64. Assuming that there is a piece of new corpus data “what is the weather tomorrow”, the model-building module 103 will only update the probability scores between the words “tomorrow”, “weather” and “what” appearing in the piece of new corpus data, and will not update the probability scores of words (e.g. “I”, “want”, “San Francisco”, “Chicago”, etc.) that are not in the piece of new corpus data. Specifically, after the fourth classified language model is updated, the occurrence number of the word “tomorrow” in the corpus data corresponding to the “daily life information query” category will increase by 1 and become 51 times, and the occurrence number of the word “weather tomorrow” will increase by 1 and become 33 times, the probability of the word “weather” being followed by the word “tomorrow” is calculated as 33/51=0.647. As for the words “I” and “want”, their occurrence numbers in the corpus data corresponding to the “daily life information query” category did not increase due to the piece of new corpus data “what is the weather tomorrow”. The probability of the word “I” being followed by the word “want” may remain the same and the calculation for this probability may be skipped. As such, the calculation amount of the model-building module 103 may be greatly reduced, which shortens the training time for the fourth classified language model.

In an embodiment, the data-storage module 102 further stores the corpus data corresponding to each category as a classified corpus. For example, the data-storage module 102 stores the corpus data (including “what is the weather tomorrow”, for example) corresponding to the category of “daily life information query” as a “daily life information corpus”. The corpus data “Who are the Eight Great Prose Masters of the Tang and Song Dynasties” corresponds to the categories of “Chinese literature” and “history”, so it will be stored in both the “Chinese literature corpus” and “history corpus”. Furthermore, the system 100 may be a distributed system that includes a plurality of computers, each of which has a storage device for storing one of the corpus (such as “history corpus”), and a processing device for updating its corresponding classified language model based on the corpus stored in its storage device. As such, the efficiency of building and updating the classified language model may be further improved.

In another embodiment, the data-storage module 102 further stores the category label of the category that corresponds to each piece of corpus data. For example, while the data-storage module 102 stores the corpus data “Who are the Eight Great Prose Masters of the Tang and Song Dynasties”, it will also store the category labels “Chinese literature” and “History” for the corpus data “Who are the Eight Great Prose Masters of the Tang and Song Dynasties”. As such, the data-storage module 102 does not need to consume double storage space for two pieces of corpus data, even though the corpus data “Who are the Eight Great Prose Masters of the Tang and Song Dynasties” corresponds to two categories. Therefore, the storage efficiency is further improved.

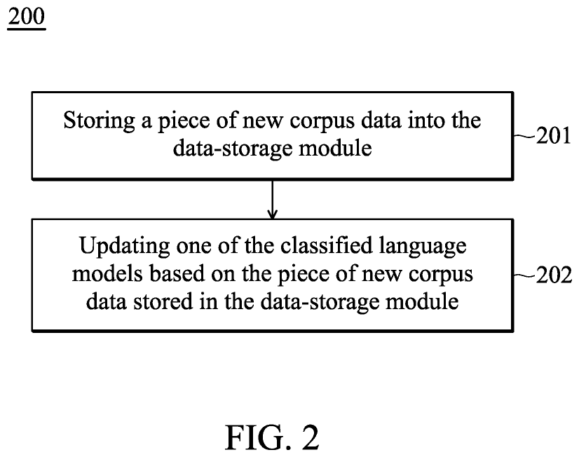

FIG. 2 is a flow diagram illustrating a method 200 used by the system 100 in FIG. 1 for updating language models, according to an embodiment of the present disclosure. As shown in FIG. 2, the method 200 may include step 201 and step 202. These steps may be carried out by the processing device of the system 100.

In step 201, a piece of new corpus data is stored into the data-storage module 102. Then, the method 200 proceeds to step 202.

As mentioned above, the corpus data (multiple pieces of corpus data) stored in the data-storage module 102 correspond to multiple categories, and the piece of new corpus data may correspond to one or more of these categories. For example, in the application scenario of interactive teaching, the corpus data stored in the data-storage module 102 may correspond to categories such as “Chinese”, “mathematics”, “history” . . . and the new corpus data “Who are the Eight Great Prose Masters of the Tang and Song Dynasties” may correspond to two of these categories, that is, “Chinese literature” and “history” categories.

In step 202, one (or more) of the classified language models is updated based on the piece of new corpus data stored in the data-storage module 102. The classified language model updated corresponds to the category that corresponds to the piece of new corpus data. This step corresponds to the model-building module 103 of the system 100.

For example, the new corpus data “Who are the Eight Great Prose Masters of the Tang and Song Dynasties” corresponds to the categories of “Chinese literature” and “history”, so the classified language models updated in step 202 may be the first classified language model and the third classified language model that respectively correspond to the “Chinese literature” and “history” categories. However, neither the second that corresponds to the category of “mathematics” nor other classified language models will be updated.

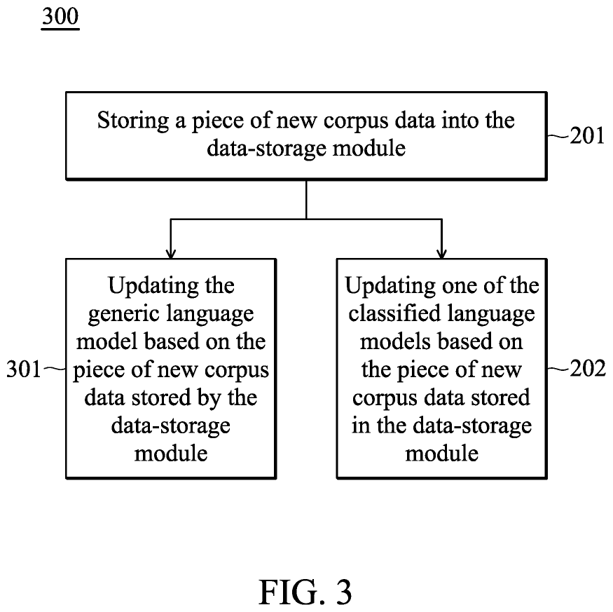

As mentioned above, in addition to updating the classified language model based on the new corpus data, the model-building module 103 may also update the generic language model based on the new corpus data. This implementation will be elaborated below with reference to FIG. 3.

FIG. 3 is a flow diagram illustrating a method 300 used by the system 100 in FIG. 1 for updating language models, according to an embodiment of the present disclosure. Compared with the method 200, the method 300 further includes a step 301, as shown in FIG. 3.

In step 301, the generic language model is updated based on the piece of new corpus data stored by the data-storage module 102. Like step 202, step 301 corresponds to the model-building module 103 of the system 100 and may be executed by the processing device of the system 100.

For example, the first classified language model and the third classified language model that respectively correspond to the “Chinese literature” and “history” categories may be updated based on the new corpus data “Who are the Eight Great Prose Masters of the Tang and Song Dynasties” in step 202, and the generic language model may be updated regardless of the categories in step 301. There is no dependency between step 301 and step 202, and the two may be executed separately. The execution order of step 301 and step 202 is not limited by the present disclosure.

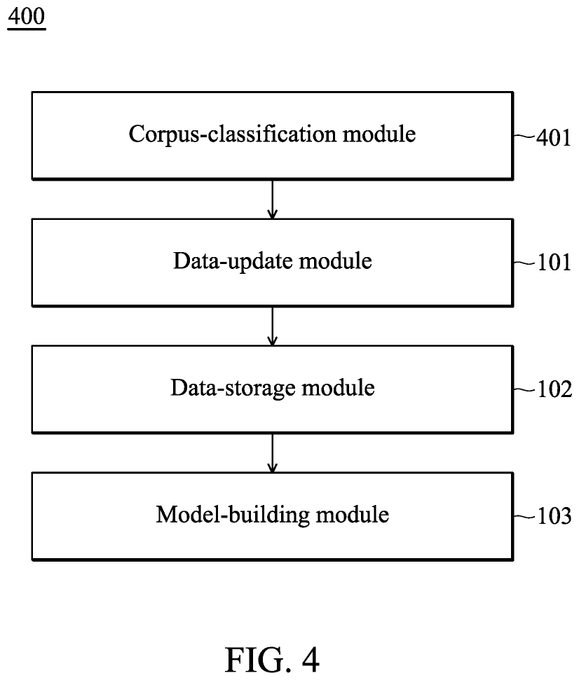

FIG. 4 is a system block diagram illustrating a system 400 for updating a language model, according to an embodiment of the present disclosure. Compared with the system 100, the system 400 further includes a corpus-classification module 401, as shown in FIG. 4. Like the data-update module 101 and the model-building module 103, the corpus-classification module 401 may be implemented by loading a program containing a plurality of instructions into the processing device of the system 100. The corpus-classification module 401 is used for automatically determining the corresponding category of corpus data (including new corpus data). Various implementations of the corpus-classification module 401 will be elaborated below.

In an embodiment, the corpus-classification module 401 may use a keyword matching approach to determine whether a piece of corpus data corresponds to a certain category. Specifically, the corpus-classification module 401 determines whether the piece of corpus data corresponds to a category according to whether at least one of the keywords of the category appears in the piece of corpus data. For example, the category “daily life information query” has keywords such as “weather”, “temperature” and “traffic conditions”, among which the word “weather” appears in the piece of corpus data “what is the weather tomorrow”, so the corpus-classification module 401 may determine that the piece of corpus data corresponds to the “daily life information query” category. The keywords for each category may be given in advance by humans or obtained by the system 400 through collecting texts from certain sources (e.g., using web crawlers to grab the texts on the official webpage of the Meteorological Bureau) and using text mining technology to extract keywords from the collected texts.

In an embodiment, on the basis of the keyword matching approach, a knowledge engineering approach may be further adopted to define more complex criteria for each category. For example, Boolean expressions or regular expressions may be used to represent the logical relationships between keywords that may be satisfied by the corpus data corresponding to a category, such as AND, OR, NOT and the combination thereof, or other more complex logic.

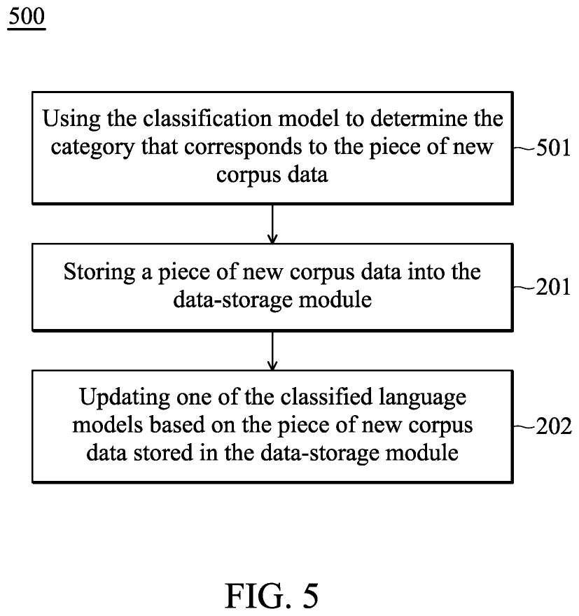

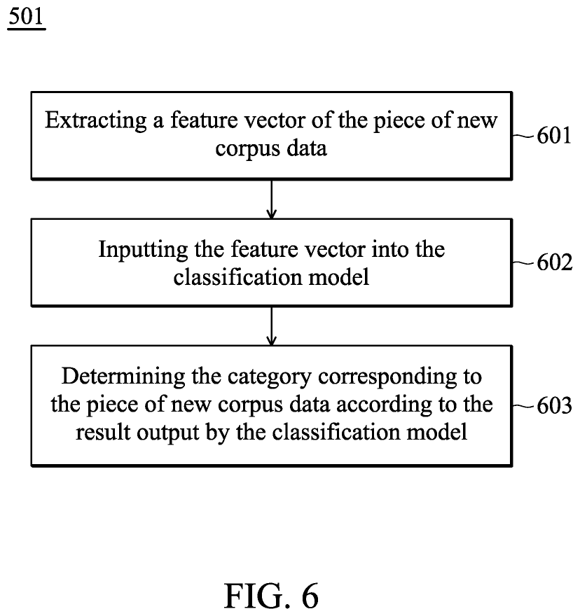

In an embodiment, the corpus-classification module 401 may use a classification model in the field of machine learning to determine the category that corresponds to the new corpus data. The implementation of the corpus-classification module 401 using the classification model will be described below with reference to FIGS. 5-6.

FIG. 5 is a flow diagram illustrating a method 500 used by the system 400 in FIG. 4 for updating language models, according to an embodiment of the present disclosure. Compared with the method 200, the method 500 further includes a step 501 before the step 201, as shown in FIG. 5

In step 501, the corpus-classification module 401 uses the classification model to determine the category (or categories) that corresponds to the piece of new corpus data. Then, the method 500 proceeds to step 202.

The classification model may be any classifier in the field of machine learning, such as decision tree, logistic regression, naive Bayes, random forest, support vector machine (SVM), or fully-connected neural network, but the present disclosure is not limited thereto. When used in step 501, the classification model has been trained in advance through repeated result feedback and parameter update until the error rate of the output result is reduced to an acceptable level. The corresponding category of the corpus data in the training data set used for training the classification model may be manually labeled, or automatically determined by the system using any of the approaches described above, such as the keyword matching approach or the knowledge engineering approach.

FIG. 6 is a flow diagram illustrating more detailed steps of step 501 in FIG. 5, according to an embodiment of the present disclosure. As shown in FIG. 6, step 501 may further include steps 601-603.

In step 601, a feature vector of the piece of the piece of new corpus data is extracted. The method then proceeds to step 602.

In this embodiment, each piece of corpus data is represented by using a vector space model. Specifically, each piece of corpus data has a feature vector (w₁, w₂, w₃, . . . wₙ) that represents the features of the piece of corpus data, where wᵢ represents the weight of the i-th feature of the piece of corpus data.

In an embodiment, a term frequency-inverse document frequency (TF-IDF) approach is used to determine each value of weight w₁-wₙ. In a text file (i.e., corpus data), the terminology “term frequency” (TF) refers to the frequency at which a word appears in the text file. This number is calculated with the length of the text file taken into account, and normalizing the term count (or word count). The terminology “inverse document frequency” (IDF) refers to the magnitude of the importance of the term/word, which may be obtained by dividing the total number of text files by the number of text files containing the term, and taking the logarithm of the resulting quotient. If the term/word corresponding to the weight wᵢ appears more frequently in the file, or the word appears less frequently in all files, the value of the weight wᵢ will be greater. Therefore, through the term frequency-inverse document frequency approach, more representative features may be extracted from the corpus data.

In step 602, the feature vector is input into the (pre-trained) classification model. The method then proceeds to step 603.

In step 603, the category corresponding to the piece of new corpus data is determined according to the result output by the classification model. For example, assuming that the result output by the classification model indicates that the probability of the new corpus data “Who are the Eight Great Prose Masters of the Tang and Song Dynasties” corresponding to the categories “Chinese literature”, “mathematics” and “history” are 90%, 30%, and 80%, respectively, then select “Chinese literature”, which has the highest probability, as the corresponding category of the piece of new corpus data. Alternatively, “Chinese subjects” and “history subjects” may both be selected as the corresponding categories of the piece of new corpus data, since their probabilities 90% and 80% are both greater than a specified threshold 70%, for example.

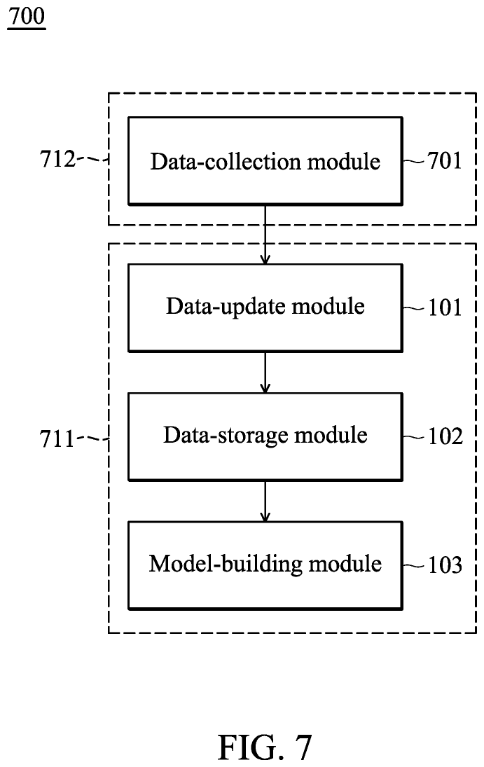

FIG. 7 is a system block diagram illustrating a system 700 for updating language models, according to another embodiment of the present disclosure. Compared with the system 100, the system 700 further includes a data collection module 701, as shown in FIG. 7. In addition, the system 700 further includes a backend server 711 and a client device 712. The backend server 711 is configured to train and/or update the language model. The client device 712 downloads the trained and/or updated language model from the backend server 711 via the network, and applies the language model to the application of speech recognition. In addition to applying the language model, the client device 712 also has a mechanism for collecting (or feeding back) new corpus data. Therefore, the data collection module 701 in FIG. 7 is implemented by the client device 712, while the data-update module 101, data-storage module 102 and model-building module 103 are implemented by the backend server 711.

In an embodiment, the data collection module 701 is used for recording the sentences that are unrecognizable by the client device 712 through the speech recognition technology (which may be any speech recognition technology that applies the language model trained by the backend server 711, but the present disclosure is not limited thereto), and for converting these unrecognizable sentences into new corpus data (i.e., these sentences are organized into a format conforming to the corpus data). In response to the amount of new corpus data accumulated exceeding a threshold, the accumulated new corpus data is uploaded to the backend server 711. It should be appreciated that although a single client device 712 is used as an example to illustrate the present embodiment, the present disclosure does not limit the number of client devices included in the system 700. For example, the backend server 711 may receive new corpus data uploaded in batches from a plurality of client devices.

In an embodiment, when converting sentences into new corpus data, the data collection module 701 may determine the corresponding category of the new corpus data and label it, according to the application scenario.

The methods described above may be implemented using computer-executable instructions. These instructions may include, for example, instructions and data that cause a general-purpose computer, special-purpose computer, or special-purpose processing device to perform a specific function or group of functions. A portion of the computer resources used may be accessed via the network. Computer-executable instructions may, for example, be binary or intermediate format instructions such as assembly language, firmware, or source code.

The system and method for updating language models provided by the present disclosure is capable of updating a language model at a rapid speed, and meanwhile improving the effectiveness of the language model in practical applications.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for updating language models, comprising:
a data-storage module, used for storing multiple pieces of corpus data corresponding to multiple categories;
a data-update module, used for storing a piece of new corpus data into the data-storage module, wherein the piece of new corpus data corresponds to one of the categories; and
a model-building module, used for constructing a plurality of classified language models, and updating one of the classified language models based on the piece of new corpus data stored in the data-storage module, wherein the classified language model updated corresponds to the category that corresponds to the piece of new corpus data.

2. The system as claimed in claim 1, wherein the classified language model uses n-grams to calculate probability scores between words.

3. The system as claimed in claim 1, wherein the model-building module updates the classified language model by only updating probability scores between words in the piece of new corpus data, and not updating probability scores of words that are not in the piece of new corpus data.

4. The system as claimed in claim 1, wherein the model-building module further updates a generic language model based on the piece of new corpus data stored in the data-storage module.

5. The system as claimed in claim 1, further comprising a corpus-classification module, using a classification model to determine the category that corresponds to the piece of new corpus data.

6. The system as claimed in claim 5, wherein the classification model is a Fully-Connected Neural Network.

7. The system as claimed in claim 5, wherein the corpus-classification module extracts a feature vector of the piece of new corpus data, inputs the feature vector into the classification model, and determines the category that corresponds to the piece of new corpus data according to a result output by the classification model.

8. The system as claimed in claim 7, wherein the corpus-classification module uses a term frequency-inverse document frequency (tf-idf) approach to extract the feature vector from the piece of new corpus data.

9. The system as claimed in claim 1, wherein the data-storage module further stores the corpus data that correspond to the category as a classified corpus.

10. The system as claimed in claim 1, wherein the data-storage module further stores a category label of the category that corresponds to each piece of corpus data.

11. The system as claimed in claim 1, further comprising a data-collection module, used for recording sentences that are unrecognizable by a client device through speech recognition technologies, and converting the sentences into multiple pieces of new corpus data;
wherein in response to the amount of new corpus data accumulated exceeding a threshold, the data-collection module uploads the accumulated new corpus data to a backend server for updating the classified language model; and
wherein the data-collection module is executed by the client device, and the data-update module, the data-storage module and the model-building module are executed by the backend server.

12. A method for updating language models, for use in a computer system, the method comprising:
storing a piece of new corpus data into a data-storage module of the computer system, wherein the data-storage module is used for storing multiple pieces of corpus data corresponding to multiple categories, and the piece of new corpus data corresponds to one of the categories; and
updating one of a plurality of classified language models based on the piece of new corpus data stored in the data-storage module, wherein the classified language model updated corresponds to the category that corresponds to the piece of new corpus data.

13. The method as claimed in claim 12, wherein the classified language model uses n-grams to calculate probability scores between words.

14. The method as claimed in claim 12, wherein the step of updating the classified language model based on the piece of new corpus data stored in the data-storage module comprises:
only updating probability scores between words in the piece of new corpus data, and not updating probability scores of words that are not in the piece of new corpus data.

15. The method as claimed in claim 12, further comprising:
updating a generic language model based on the piece of new corpus data.

16. The method as claimed in claim 12, further comprising:
using a classification model to determine the category that corresponds to the piece of new corpus data.

17. The method as claimed in claim 16, wherein the classification model is a Fully-Connected Neural Network.

18. The method as claimed in claim 16, wherein the step of using the classification model to determine the category that corresponds to the piece of new corpus data further comprises:
extracting a feature vector of the piece of new corpus data;
inputting the feature vector into the classification model; and
determining the category that corresponds to the piece of new corpus data according to a result output by the classification model.

19. The method as claimed in claim 18, wherein the step of extracting the feature vector of the piece of new corpus data comprises:
using a term frequency-inverse document frequency (tf-idf) approach to extract the feature vector from the piece of new corpus data.

20. The method as claimed in claim 12, further comprising:
storing the corpus data that correspond to the category as a classified corpus.

21. The method as claimed in claim 12, further comprising:
storing a category label of the category that corresponds to the piece of new corpus data into the data-storage module.
